(19) United States
(12) Patent Application Publication
(10) Pub. No.: US 2008/0003996 A1
(43) Pub. Date: Jan. 3, 2008

(54) Controlling mobile messaging remotely

(75) Inventors: Toni Strandell, Espoo (FI); Tuomas Tammi, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/477,762

(22) Filed: Jun. 30, 2006

(51) Int. Cl. H04M 3/00; H04Q 7/20

(52) U.S. Cl. 455/420; 455/466; 455/412.1

(57) ABSTRACT

The invention allows controlling mobile messaging remotely from a computing device. A wireless Internet connection is established from a mobile device to a gateway. Then, the established wireless Internet connection is monitored at the mobile device. If a messaging request is received via the monitored wireless Internet connection, then the mobile device is operated in response to the messaging request.

### BACKGROUND OF THE INVENTION

1. Field of the Invention

The invention relates to telecommunications. In particular, the invention relates to a novel and improved remote control of mobile messaging via a web interface.

2. Description of the Related Art

These days, mobile telephones are a common way to make voice calls. A typical mobile telephone is compact and light and therefore convenient to carry around. In many situations, a mobile telephone is also convenient enough to operate directly via its interface, such as a keypad and a display.

However, there are also situations in which one might want to be able to control the mobile telephone remotely, that is, via an interface other than the one physically attached to the mobile telephone device.

For example, when one is using a personal computer or a laptop computer and needs to make a call or to send a message, e.g. a short message or an email message, with one's mobile telephone, one has to suspend whatever one was doing with the computer and pick up the mobile telephone and dial the telephone number to be called manually with the keypad or other such input device of the mobile telephone or to type the message for the recipient and send it by using the mobile telephone.

In such cases, one might want to operate the mobile telephone remotely utilizing the same personal computer or laptop computer one is already using. This would typically allow typing and sending messages with a few mouse clicks and some typing, rather than having to suspend one's work and start handling the mobile telephone.

It is known to control a device, e.g. a mobile device remotely via a non-wireless Internet connection, such as a Bluetooth connection, an infrared connection or a wired connection, from a personal computer in order to install software to the mobile telephone, to delete software from the mobile telephone, to synchronize files and/or data between the mobile telephone and the computer, to edit calendar entries, or to edit phonebook entries.

Furthermore, it is known to control a device remotely via a non-wireless Internet connection, such as a Bluetooth connection or an infrared connection, from a personal computer equipped with customized remote control software in order to make calls with the mobile telephone or to send messages with the mobile telephone.

Furthermore, known solutions often require installing special remote control software in the computer. For example, such solutions cannot be utilized when one is using a computer provided by a net café, a net kiosk, a library, or an airport. Obviously, one cannot install any software in such publicly provided computers.

Therefore, there exists a need for a solution that allows controlling mobile messaging remotely from a local computing device without having to install any software in the local computing device.

### SUMMARY OF THE INVENTION

A first aspect of the invention is a method in which a wireless Internet connection is established from a mobile device to a gateway. Then, the established wireless Internet connection is monitored at the mobile device. If a messaging request is received via the monitored wireless Internet connection, the mobile device is operated in response to the messaging request.

Further in accordance with the first aspect in one embodiment, the method may comprise at least one of the following: the mobile device is operated to send a message to a recipient indicated by the received messaging request via a mobile communication network, the mobile device is operated to store a message received in the messaging request in the mobile device, and the message is a short message, a multimedia message or an email message. In an embodiment of the invention, the method of the first aspect is performed by a data-processing device controlled by a computer program embodied on a computer readable medium.

A second aspect of the invention is a mobile device which comprises a remote controller configured to establish a wireless Internet connection from the mobile device to a gateway, to monitor the established wireless Internet connection, and to operate the mobile device in response to a messaging request received via the monitored wireless Internet connection.

Further in accordance with the second aspect in one embodiment, the remote controller may be configured to perform at one of the following: remote controller is configured to operate the mobile device to send a message to a recipient indicated by the received messaging request via a mobile communication network, and the remote controller is configured to operate the mobile device to store a message received in the received messaging request in the mobile device.

A third aspect of the invention is a method in which a wireless Internet connection is established at a gateway with at least one mobile device. The gateway assigns a connection identifier to each mobile device in response to the establishment of the wireless Internet connection from the at least one mobile device. Furthermore, the gateway receives from a web server a messaging request addressed to an assigned connection identifier and forwards the received messaging request to the mobile device indicated by the assigned connection identifier.

Further in accordance with the third aspect in one embodiment, the method may comprise at least one of the following: the messaging request comprises a connection address of a receiving mobile device, step of assigning comprises assigning at the gateway a first connection identifier to a first mobile device and a second connection identifier to a second mobile device in response to an establishment of a wireless Internet connection from the mobile devices to the gateway; the step of receiving comprises receiving at the gateway, from a web server, a messaging request addressed to the assigned second connection identifier; and the step of forwarding comprises forwarding the messaging request from the gateway to the second mobile device; the gateway receives from the web server a second messaging request addressed to the first connection identifier and forwards the second messaging request to the first mobile device indicated by the assigned first connection identifier, and the message is a short message, a multimedia message or an email message. In an embodiment of the invention, the method of the third aspect is performed by a data-processing device controlled by a computer program embodied on a computer readable medium.

A fourth aspect of the invention is an apparatus which comprises a gateway configured to establish a wireless Internet connection with at least one mobile device; to assign a connection identifier to each mobile device in response to the establishment of the wireless Internet connection from the at least one mobile device to the gateway; to receive a messaging request addressed to an assigned connection identifier; and to forward the received messaging request to the mobile device indicated by the assigned connection identifier.

A fifth aspect of the invention is a method in which a web server receives an access from a user operating a first mobile device. Then, the web server generates a message destined to a second mobile device based on user instructions. Furthermore, the web server checks from a gateway, whether the second mobile device has an active connection with the gateway. The web server sends to the gateway a messaging request addressed to a connection identifier assigned by the gateway to the second mobile device, when the second mobile device has an active connection with the gateway. Correspondingly, the web server sends to the gateway a messaging request addressed to a connection identifier assigned by the gateway to the first mobile device, when the second mobile device does not has an active connection with the gateway. In an embodiment of the invention, the method of the fifth aspect is performed by a data-processing device controlled by a computer program embodied on a computer readable medium.

A sixth aspect of the invention is an apparatus which comprises a web server configured to receive an access from a user operating a first mobile device; to generate a message destined to a second mobile device based on user instructions; to check, from a gateway, whether the second mobile device has an active connection with the gateway; to send to the gateway a messaging request addressed to a connection identifier assigned by the gateway to the second mobile device, when the second mobile device has an active connection with the gateway; and to send to the gateway a messaging request addressed to a connection identifier assigned by the gateway to the first mobile device, when the second mobile device does not has an active connection with the gateway.

A seventh aspect of the invention is a method in which a wireless Internet connection is established from at least one mobile device to a gateway. The gateway assigns a connection identifier for each the mobile device in response to the establishment of the wireless Internet connection from the at least one mobile device to the gateway. Each mobile device then monitors the established wireless Internet connection. Some time after that a web site enabling message sending to mobile devices is accessed with a web browser included in a computing device. The user selects with the web browser a receiving mobile device. Then, the web server checks from the gateway, whether the receiving mobile device has an active connection with the gateway. If the active connection exists, the web server sends to the gateway a messaging request addressed to a connection identifier assigned by the gateway to the receiving mobile device. If there does not exist an active connection, the web server sends to the gateway a messaging request addressed to a connection identifier assigned by the gateway to the sending mobile device. The gateway forwards the received messaging request to the mobile device indicated by the assigned connection identifier. Finally, the mobile device indicated by the assigned connection identifier is operated in response to the messaging request received via the monitored wireless Internet connection.

Further in accordance with the seventh aspect in one embodiment, the method may comprise at least one of the following: the mobile device indicated by the assigned connection identifier is operated to send a message to a recipient indicated by the received messaging request via a mobile communication network, and the mobile device indicated by the assigned connection identifier is operated to store a message received in the messaging request in the mobile device.

An eighth aspect of the invention is a system which comprises at least one mobile device and a remote controller included in the at least one mobile device and configured to establish a wireless Internet connection from the mobile device to a gateway; to monitor the established wireless Internet connection at the mobile device; and to operate the mobile device in response to a messaging request received via the monitored wireless Internet connection. The system further comprises a gateway configured to establish a wireless Internet connection with at least one mobile device; to assign a connection identifier to each mobile device in response to the establishment of the wireless Internet connection from the at least one mobile device to the gateway; to receive a messaging request addressed to an assigned connection identifier; and to forward the received messaging request to the mobile device indicated by the assigned connection identifier. The system further comprises a computing device comprising a web browser configured to access web sites. The system further comprises a web server configured to receive an access from a user operating a first mobile device; to generate a message destined to a second mobile device based on user instructions; to check, from a gateway, whether the second mobile device has an active connection with the gateway; to send to the gateway a messaging request addressed to a connection identifier assigned by the gateway to the second mobile device, when the second mobile device has an active connection with the gateway; and to send to the gateway a messaging request addressed to a connection identifier assigned by the gateway to the first mobile device, when the second mobile device does not has an active connection with the gateway.

In one embodiment of the invention, the message is a short message, a multimedia message or an email message.

A ninth aspect of the invention is a mobile device comprising means for establishing a wireless Internet connection from the mobile device to a gateway, means for monitoring the established wireless Internet connection, and means for operating the mobile device in response to a messaging request received via the monitored wireless Internet connection.

A tenth aspect of the invention is An apparatus comprising means for establishing a wireless Internet connection with at least one mobile device; means for assigning a connection identifier to each mobile device in response to the establishment of the wireless Internet connection from the at least one mobile device to the gateway; means for receiving a messaging request addressed to an assigned connection identifier; and means for forwarding the received messaging request to the mobile device indicated by the assigned connection identifier.

An eleventh aspect of the invention is an apparatus comprising means for receiving an access from a user operating a first mobile device; means for generating a message destined to a second mobile device based on user instructions; means for checking, from a gateway, whether the second mobile device has an active connection with the gateway; means for sending to the gateway a messaging request addressed to a connection identifier assigned by the gateway to the second mobile device, when the second mobile device has an active connection with the gateway; and means for sending to the gateway a messaging request addressed to a connection identifier assigned by the gateway to the first mobile device, when the second mobile device does not has an active connection with the gateway.

The invention enables controlling mobile messaging from a local computing device without requiring any control software to be installed in the local computing device. Furthermore, the invention allows controlling mobile messaging remotely from a local computing device via a wireless Internet connection. As a result, the invention enables controlling mobile messaging remotely from a local computing device even in situations where non-wireless Internet connections between the mobile device and the computing device, such as a Bluetooth connection or an infrared connection, are unavailable.

Furthermore, the sender of the message does not need to change his focus from the computing device to his mobile device in order to send the message.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1a is a block diagram illustrating a system according to one embodiment of the invention,

FIG. 1b is a block diagram illustrating a system according to another embodiment of the invention,

FIG. 2a is a diagram illustrating a method according to one embodiment of the invention, and

FIG. 2b is a diagram illustrating a method according to another embodiment of the invention.

### DETAILED DESCRIPTION OF THE PREFERRED EMBODIMENTS

Reference will now be made in detail to the embodiments of the invention, examples of which are illustrated in the accompanying drawings.

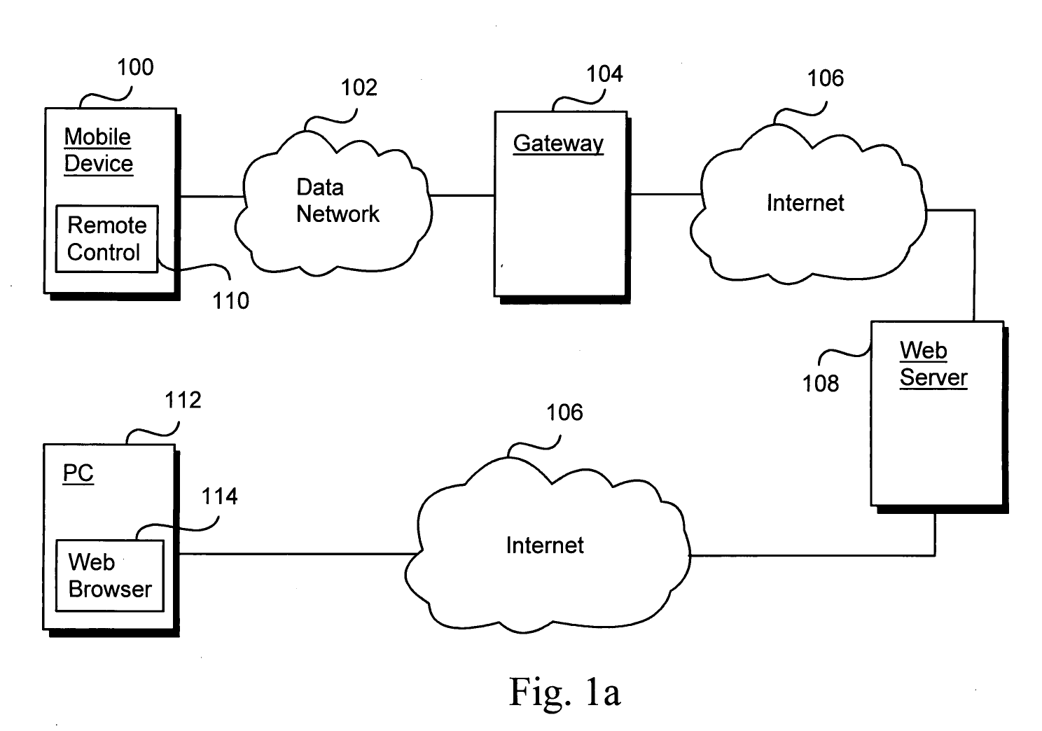

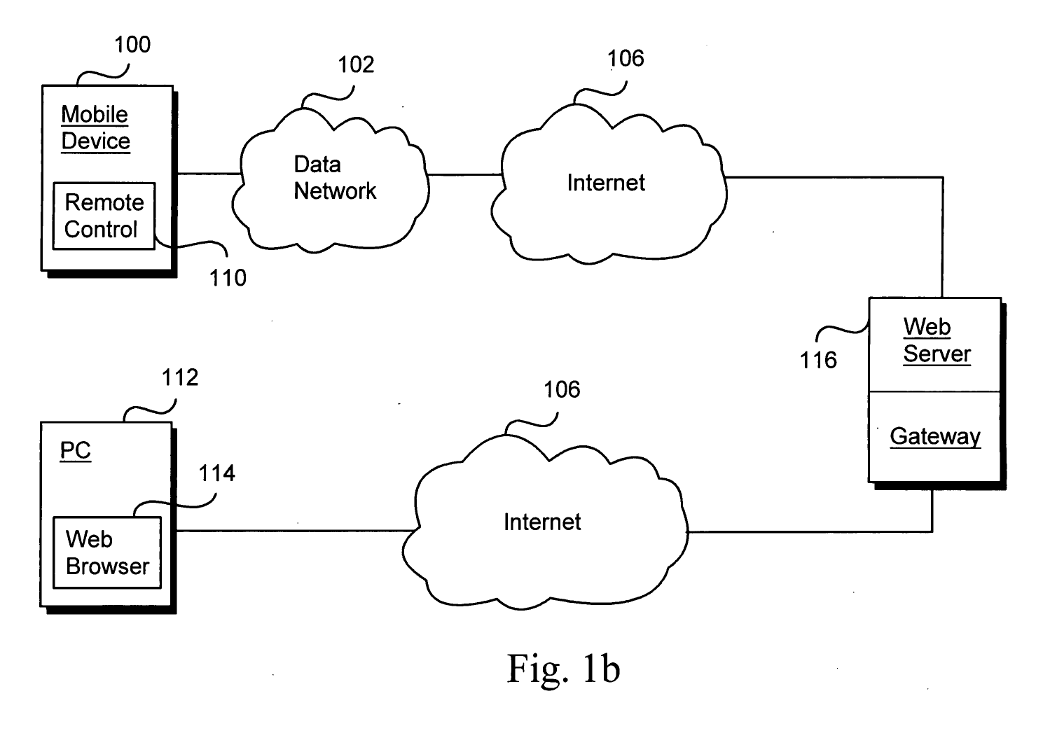

FIG. 1a illustrates a system according to one embodiment of the invention. The system of the embodiment of the invention illustrated in FIG. 1a comprises a mobile device 100 connected to a gateway 104 via a data network 102. In the embodiment illustrated in FIG. 1a the mobile device 100 is a mobile telecommunication device such as a mobile telephone. Although FIG. 1a discloses that the system comprises only one mobile device 100 there may also be other mobile devices connected to the gateway 104.

The system of the embodiment of the invention illustrated in FIG. 1a further comprises a remote controller 110. The remote controller 110 is included in the mobile device 100. Furthermore, the remote controller 110 is configured to establish a wireless Internet connection from the mobile device 100 to the gateway 104. The remote controller 110 is further configured to monitor the established wireless Internet connection. The remote controller 110 is further configured to operate in response to a messaging request received via the monitored wireless Internet connection.

Furthermore, the remote controller 110 may be configured to operate the mobile device to send a message to a recipient indicated by the received messaging request via a mobile communication network. Furthermore, the remote controller 110 may be configured to operate the mobile device to store a message received in the received messaging request in the mobile device.

In an embodiment, the remote controller 110 is implemented as software. For example, the remote controller 110 may comprise a mobile web server module (not illustrated) comprising e.g. a mobile Apache (mApache) web server which is able to create wireless Internet connections and to listen out for incoming messaging requests, and which therefore can be reached by a web server 108 via the gateway 104. In addition to the mobile web server module, the remote controller 110 may comprise a command module (not illustrated) able to operate the mobile device 100 as disclosed above. Alternatively, the mobile web server module may be configured to operate the mobile device 100 directly. In another embodiment, the remote controller 110 is implemented as hardware.

For example, if the remote controller 110 comprises the mobile web server module, the mobile web server module may be configured to maintain a first web page which, when called by the web server 108 with the messaging request, causes a program (e.g. a program comprised in the command module) to be run on the mobile device 100 for operating the mobile device 100 to send a message to a recipient indicated by the received messaging request. Correspondingly, the mobile web server module may be configured to maintain a second web page which, when called by the web server 130 causes a program (which may be the same program as above or it may another program) to be run on the mobile device 100 for operating the mobile device 100 to store a message received in the received messaging request in the mobile device 100.

Alternatively, the mobile web server module may be configured to maintain a single web page that can be called with different parameters resulting in different actions taken. For example, when called by the web server 108 with messaging request comprising a first set of parameters (identifying the recipient of a message), the single web page causes a program to be run on the mobile device 100 for initiating a message sending operation to the identified recipient. The recipient may be identified with a telephone number, an email address or an IP address. Correspondingly, when called by the web server 108 with the messaging request comprising a second set of parameters (that instruct to store a message in the mobile device 100), the single web page causes a program to be run on the mobile device 100 for storing the message received in the messaging request in the mobile device 100.

The system of the embodiment of the invention illustrated in FIG. 1a further comprises the gateway 104 configured to assign a connection identifier indicating the mobile device 100 in response to the establishment of the wireless Internet connection from the mobile device 100 to the gateway 104. The connection identifier is e.g. a Uniform Resource Identifier (URI).

The gateway 104 is further configured to receive from the web server 108 a messaging request addressed to an assigned connection identifier. The gateway 104 is further configured to forward the messaging request to a mobile device indicated by the assigned connection identifier, i.e. the mobile device 100 in the example illustrated in FIG. 1a.

The gateway 104 and the mobile device 100 are connected to each other over a wireless Internet network 102 which in the example illustrated in FIG. 1a may be a General Packet Radio Service (GPRS) enabled cellular network. Correspondingly, the wireless Internet connection established between the mobile device 100 and the gateway 104 is a GPRS connection in the example illustrated in FIG. 1a. In another embodiment, the wireless Internet network 102 is e.g. a Wireless Local Area Network (WLAN) enabled cellular network in which case the wireless Internet connection established between the mobile device 100 and the gateway 104 is a WLAN connection. In yet another embodiment, the wireless Internet network 102 is e.g. a 3rd Generation Partnership Project (3GPP) enabled cellular network in which case the wireless Internet connection established between the mobile device 100 and the gateway 104 is a 3GPP data connection.

The system of the embodiment of the invention illustrated in FIG. 1a further comprises a computing device 112 which comprises a web browser 114 configured to access web sites. The computing device 112 may be e.g. a conventional personal computer or a laptop computer. Correspondingly, the web browser 114 may be a conventional web browser. The invention requires no special or customized control software in the computing device 112. Rather, a regular web browser 114 is sufficient.

The system of the embodiment of the invention illustrated in FIG. 1a further comprises the web server 108 configured to receive an access from a user operating the mobile device 100. The request itself originates from the computing device 112. The web server 108 is further configured to generate a message destined to a second mobile device based on user instructions. In other words, the user using the web browser 114 as a user interface generates a message (e.g. a short message (SMS) of a mobile communication network, a multimedia message (MMS) of a mobile communication network, en email etc,) to be sent to one or more recipients.

The web server 108 is further configured to check from the gateway 104, whether the second mobile device has an active connection with the gateway, to send to the gateway 104 a messaging request addressed to a connection identifier assigned by the gateway to the second mobile device, when the second mobile device has an active connection with the gateway 104, and to send to the gateway 104 a messaging request addressed to a connection identifier assigned by the gateway 104 to the first mobile device, when the second mobile device does not has an active connection with the gateway 104.

The computing device 112 and the web server 108 are connected to each other over Internet 106 in the example illustrated in FIG. 1a. The web server 108 and the gateway 104 are also connected to each other over the Internet 106 in the example illustrated in FIG. 1a. The web browser 114 included in the computing device 112 may communicate with the web server 108 e.g. by utilizing Hypertext Transfer Protocol (HTTP) in a manner known to a person skilled in the art.

Although not disclosed in FIG. 1a, the mobile device 110 may comprise several other elements or components, e.g. at least one memory, a central processing unit, a receiver for wireless communication, a transmitter for wireless communication, a circuit board, a display etc.

FIG. 1b illustrates a system according to another embodiment of the invention. In the embodiment disclosed in FIG. 1b, the gateway and the web server are located on the same server 116. Yet in another embodiment, they may be implemented as one piece of software. A person skilled in the art understands that in this case some sort of inter-process communication mechanism may be used. For the remaining elements of FIG. 1b reference is made to FIG. 1a and the corresponding description.

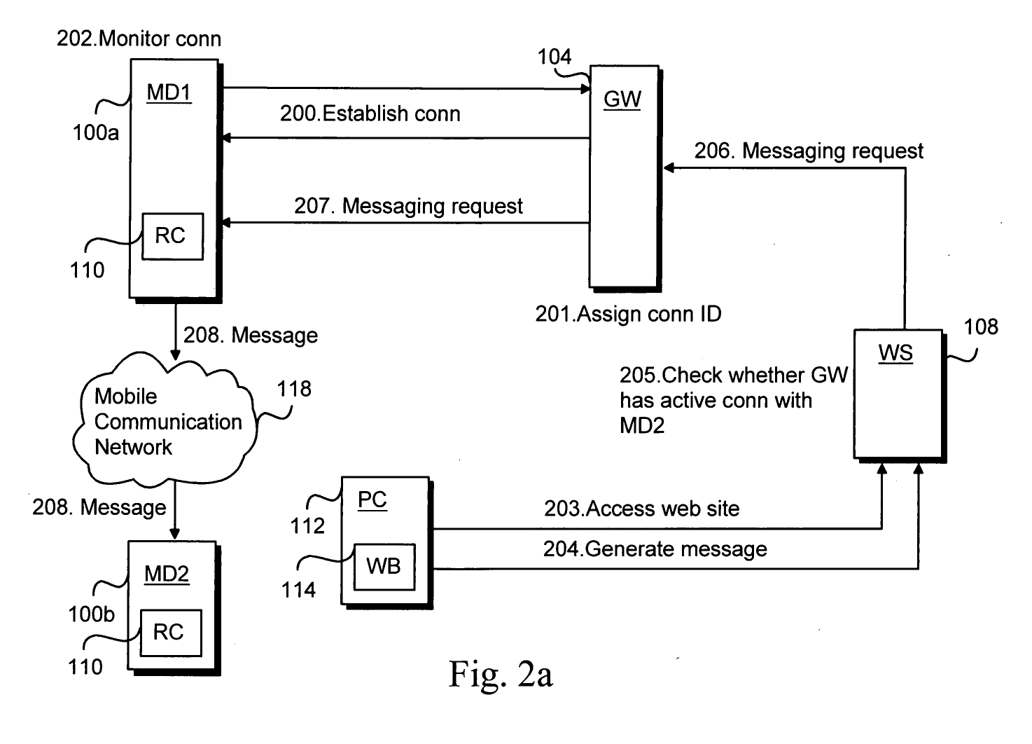

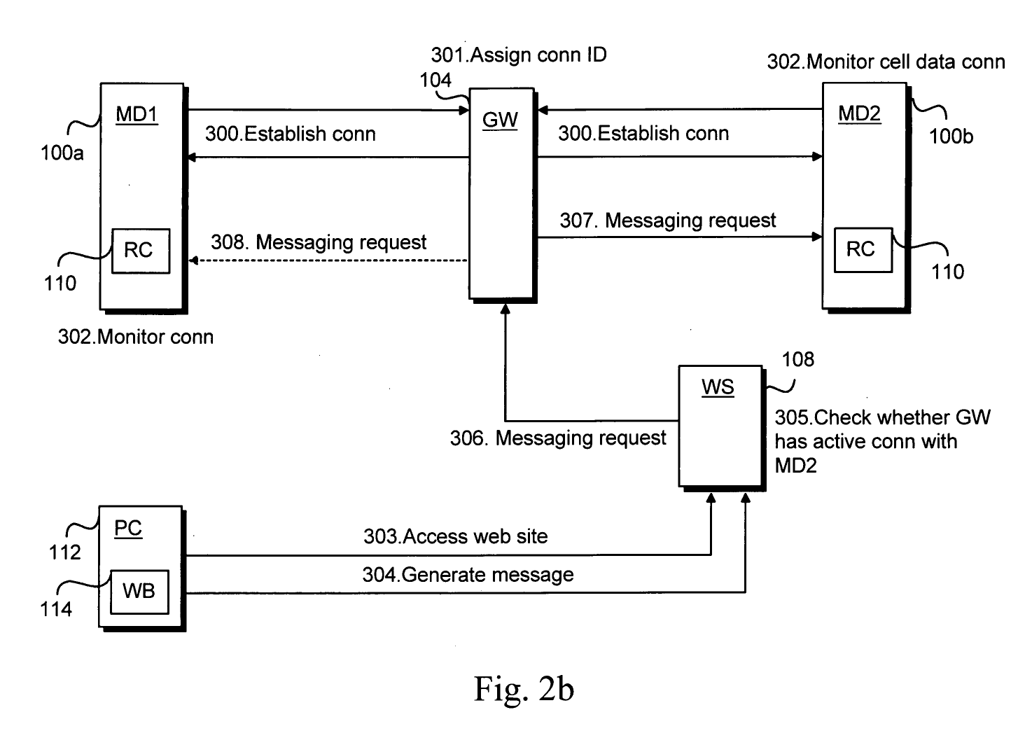

FIG. 2a illustrates a method according to one embodiment of the invention. First, the remote controller 110 establishes a wireless Internet connection from the mobile device 100a to the gateway 104, step 200. Then, in response, the gateway 104 assigns a connection identifier indicating the mobile device 100a, step 201. At step 202, the remote controller 110 begins to monitor the established wireless Internet connection by listening out for incoming requests. As a result, the messaging service provided by the invention is now activated.

Some time later, the user of the mobile device 100a decides to send a message, e.g. a short message (SMS), a multimedia message (MMS) or an email message, with the computing device 112 to at least one intended recipient. However, the user is engrossed with a task involving the computing device 112 and does not wish to pick up the mobile device 100a and start typing the message with it. Therefore, at steps 203 and 204, the user accesses a web site at the web server 108 with the web browser 114 included in the computing device 112 and starts generating a message. The web site may display contact information specific to the user of the mobile device 100a. In an embodiment, the user is authenticated e.g. via a log-on procedure (involving e.g. a user name and password) before allowed to access the web site. The contact information may be stored e.g. on the data base arranged in connection with the web server 108. Obviously, there may be several pieces of contact information stored in the data base, each being specific to a mobile device of a different user. In such a case, the log-on procedure may be utilized in determining which set of contact information to display to each user on the web site.

The contact information specific to the mobile device 100a of the user may be obtained to the web server 108 and data base e.g. from the mobile device 100a while the user utilizes the messaging remote control service provided by the invention for the first time, that is, while the mobile device 100a of the user and the web server 108 communicate for the first time. In other words, the contact information may be transferred to the web server 108 from the mobile device 100a. As is known, people often maintain a phonebook type of list of repeatedly used telephone numbers or email addresses in their mobile telephones. Later on, the contact information may be updated e.g. by the web server 108 polling the mobile device 110a via the gateway 104.

The web site may display a set of contact information for example as rows where each row comprises a name of a contact and a telephone number/email address associated with that contact. Furthermore, each row may comprise e.g. a control button, the pressing of which selects the corresponding contact and telephone number/email address for messaging procedure of the invention.

At step 205 the web server 108 checks whether the intended recipient (a second mobile device 100b) has an active connection with the gateway 104. In the example of FIG. 2a, the second mobile device 100b does not have an active connection with the gateway 104. At step 206 the web server 108 sends a messaging request to the gateway 104. The messaging request instructs the mobile device 100a to send the message to the second mobile device 100b in a conventional manner via a mobile communication network 118. The mobile communication network may comprises any applicable mobile communication network, e.g. a Global System for Mobile Communications (GSM) network, a Wideband Code Division Multiple Access (WCDMA) network etc. The messaging request at step 206 also identifies the mobile device 100a by a connection identifier assigned by the gateway 104 to the mobile device 100a in the connection establishment procedure at step 200. Based on the connection identifier the gateway 104 is able to forward the messaging request at step 207 to the right mobile device 100a and to the remote controller 110 included in the mobile device 100a. Furthermore, the messaging request comprises also the actual message generated by the user and the connection address (e.g. a phone number or an email address) of the second mobile device 100b. Next, in response to the received messaging request, the remote controller 110 operates the mobile device 100a to send the message to the second mobile device 100b via the mobile communication network 118, step 208.

In one embodiment of FIG. 2a the mobile device 100a may send e.g. status information to the gateway 104, which relays the status information to the web server 108. The status information may e.g. disclose whether the sending of the message to the second mobile device 100b was successful. The web server 108 may also show the status information to the user of the computing device 112.

FIG. 2b illustrates a method according to another embodiment of the invention. First, the remote controller 110 establishes a wireless Internet connection from the mobile devices 100a and 100b to the gateway 104, step 300. Then, in response, the gateway 104 assigns a unique connection identifier indicating each mobile device 100a and 100b, step 301. At step 302, the remote controller 110 begins to monitor the established wireless Internet connection by listening out for incoming requests. As a result, the messaging service provided by the invention is now activated. It is apparent that the establishment of the wireless Internet connection from the mobile devices 100a and 100b to the gateway 104 does not in practice happen simultaneously.

Some time later, the user of the mobile device 100a decides to send a message, e.g. a short message (SMS), a multimedia message (MMS) or an email message, with the computing device 112 to at least one intended recipient. However, the user is engrossed with a task involving the computing device 112 and does not wish to pick up the mobile device 100a and start typing the message with it. Therefore, at steps 303 and 304, the user accesses a web site at the web server 108 with the web browser 114 included in the computing device 112 and starts generating a message. The web site may display contact information specific to the user of the mobile device 100a. In an embodiment, the user is authenticated e.g. via a log-on procedure (involving e.g. a user name and password) before allowed to access the web site. The contact information may be stored e.g. on the data base arranged in connection with the web server 108. Obviously, there may be several pieces of contact information stored in the data base, each being specific to a mobile device of a different user. In such a case, the log-on procedure may be utilized in determining which set of contact information to display to each user on the web site.

The contact information specific to the mobile device 100a may be obtained to the web server 108 and data base e.g. from the mobile device 100a while the user utilizes the messaging remote control service provided by the invention for the first time, that is, while the mobile device 100a of the user and the web server 108 communicate for the first time. In other words, the contact information may be transferred to the web server 108 from the mobile device 100a. As is known, people often maintain a phonebook type of list of repeatedly used telephone numbers or email addresses in their mobile telephones. Later on, the contact information may be updated e.g. by the web server 108 polling the mobile device 100a via the gateway 104.

The website may display a set of contact information for example as rows where each row comprises a name of a contact and a telephone number/email address associated with that contact. Furthermore, each row may comprise e.g. a control button, the pressing of which selects the corresponding contact and telephone number/email address for messaging procedure of the invention.

At step 305 the web server 108 checks whether the intended recipient (a second mobile device 100b) has an active connection with the gateway 104. In the example of FIG. 2b, the second mobile device 100b has an active connection with the gateway 104. The connection between the mobile devices and the gateway 104 may comprise a General Packet Radio Service (GPRS) connection, a Wireless Local Area Network (WLAN) connection or 3rd Generation Partnership Project (3GPP) data connection. At step 306 the web server 108 sends a messaging request to the gateway 104. The messaging request instructs the gateway 104 to send the message to the second mobile device 100b in via the established wireless Internet connection. The messaging request at step 306 also identifies the mobile device 100b by a connection identifier assigned by the gateway 104 to the mobile device 100b in the connection establishment procedure at step 300. Based on the connection identifier the gateway 104 is able to forward the messaging request at step 307 to the right mobile device 100b and to the remote controller 110 included in the mobile device 100b. Furthermore, the messaging request comprises also the actual message generated by the user of the mobile device 100a. Next, in response to the received messaging request, the remote controller 110 operates the mobile device 100b to place the message in the native messaging application's “Inbox” folder.

The messaging request from the web server 108 at step 306 may also instruct the gateway to send a copy of the message also to the mobile device 100a. Therefore, at step 308 the gateway sends a copy of the message to the mobile device 100a. In response to the received messaging request, the remote controller 110 operates the mobile device 100a to place the message in the native messaging application's “Sent” folder.

The invention may be implemented with software in various system elements, e.g. in a mobile device and a network server comprising at least one of the gateway and the web server. The mobile device and the network server may then comprise at least one memory. The memory may refer to a single memory or memory area or to a plurality memories or memory areas that may include e.g. random access memories (RAM), read-only memories (ROM) etc. The memory may also include other applications or software components that are not described in more detail and also may include the computer program (or portion thereof), which when executed on a central processing unit performs at least some of the method characteristics disclosed in the invention. The central processing unit may also include memory or a memory may be associated therewith which may include the computer program (or portion thereof) which when executed on the central processing unit performs at least some of the method characteristics disclosed in the invention.

It is obvious to a person skilled in the art that with the advancement of technology, the basic idea of the invention may be implemented in various ways. The invention and its embodiments are thus not limited to the examples described above, instead they may vary within the scope of the claims.

What is claimed is:

1. A method comprising:
establishing a wireless Internet connection from a mobile device to a gateway;
monitoring the established wireless Internet connection at the mobile device; and
operating the mobile device in response to a messaging request received via the monitored wireless Internet connection.

2. The method according to claim 1, wherein operating the mobile device comprises:
operating the mobile device to send a message to a recipient indicated by the received messaging request via a mobile communication network.

3. The method according to claim 1, wherein operating the mobile device comprises:
operating the mobile device to store a message received in the messaging request in the mobile device.

4. The method according to claim 1, wherein the message is a short message, a multimedia message or an email message.

5. The method according to claim 1, wherein the method is performed by a data-processing device controlled by a computer program embodied on a computer readable medium.

6. A mobile device, comprising:
a remote controller configured to establish a wireless Internet connection from the mobile device to a gateway, to monitor the established wireless Internet connection, and to operate the mobile device in response to a messaging request received via the monitored wireless Internet connection.

7. The mobile device according to claim 6, wherein the remote controller is configured to operate the mobile device to send a message to a recipient indicated by the received messaging request via a mobile communication network.

8. The mobile device according to claim 6, wherein the remote controller is configured to operate the mobile device to store a message received in the received messaging request in the mobile device.

9. A method comprising:
establishing at a gateway a wireless Internet connection with at least one mobile device;
assigning at the gateway a connection identifier to each mobile device in response to the establishment of the wireless Internet connection from the at least one mobile device;
receiving at the gateway a messaging request addressed to an assigned connection identifier; and
forwarding at the gateway the received messaging request from the gateway to the mobile device indicated by the assigned connection identifier.

10. The method according to claim 9, wherein the messaging request comprises a connection address of a receiving mobile device.

11. The method according to claim 9, wherein:
assigning the connection identifier comprises assigning at the gateway a first connection identifier to a first mobile device and a second connection identifier to a second mobile device in response to an establishment of a wireless Internet connection from the mobile devices to the gateway;
receiving the messaging request comprises receiving at the gateway, from a web server, a messaging request addressed to the assigned second connection identifier; and
forwarding the received messaging request comprises forwarding the messaging request from the gateway to the second mobile device.

12. The method according to claim 11, further comprising:
receiving at the gateway, from the web server, a second messaging request addressed to the first connection identifier; and
forwarding the second messaging request from the gateway to the first mobile device indicated by the assigned first connection identifier.

13. The method according to claim 9, wherein the method is performed by a data-processing device controlled by a computer program embodied on a computer readable medium.

14. An apparatus comprising:
a gateway configured to establish a wireless Internet connection with at least one mobile device; to assign a connection identifier to each mobile device in response to the establishment of the wireless Internet connection from the at least one mobile device to the gateway; to receive a messaging request addressed to an assigned connection identifier; and to forward the received messaging request to the mobile device indicated by the assigned connection identifier.

15. A method comprising:
receiving at a web server an access from a user operating a first mobile device;
generating at the web server a message destined to a second mobile device based on user instructions;
checking at the web server, from a gateway, whether the second mobile device has an active connection with the gateway;
sending, from the web server to the gateway, a messaging request addressed to a connection identifier assigned by the gateway to the second mobile device, when the second mobile device has an active connection with the gateway; and
sending, from the web server to the gateway, a messaging request addressed to a connection identifier assigned by the gateway to the first mobile device, when the second mobile device does not has an active connection with the gateway.

16. The method according to claim 15, wherein the method is performed by a data-processing device controlled by a computer program embodied on a computer readable medium.

17. An apparatus comprising:
a web server configured to receive an access from a user operating a first mobile device; to generate a message destined to a second mobile device based on user instructions; to check, from a gateway, whether the second mobile device has an active connection with the gateway; to send to the gateway a messaging request addressed to a connection identifier assigned by the gateway to the second mobile device, when the second mobile device has an active connection with the gateway; and to send to the gateway a messaging request addressed to a connection identifier assigned by the gateway to the first mobile device, when the second mobile device does not has an active connection with the gateway.
